(19) United States
(12) Patent Application Publication
(10) Pub. No.: US 2026/0244528 A1
(43) Pub. Date: Aug. 20, 2026

(54) DATA STORAGE METHOD, DEVICE, STORAGE MEDIUM, AND SYSTEM

(71) Applicant: CLOUD INTELLIGENCE ASSETS HOLDING (SINGAPORE) PRIVATE LIMITED, Singapore (SG)

(72) Inventor: Zhaosheng ZHU, Hangzhou (CN)

(21) Appl. No.: 19/161,688

(22) PCT Filed: Feb. 26, 2024
(86) PCT No.: PCT/CN2024/078628

§ 371 Date: Sep. 2, 2025

(30) Foreign Application Priority Data
Mar. 2, 2023 (CN) 202310209425.2

(51) Int. Cl. G06F 11/10; G11B 20/18

(52) U.S. Cl. CPC G06F 11/1004; G11B 20/1833

(57) ABSTRACT

A method, including: determining, in response to a data write task, a target magnetic tape group from a plurality of magnetic tape groups, where a quantity of magnetic tapes included in the target magnetic tape group is a quantity n that is set based on EC configuration information; obtaining p data blocks corresponding to the task, and generating q parity blocks based on the p data blocks, where n=p+q; determining target magnetic tapes respectively corresponding to the p data blocks and the q parity blocks and first physical storage spaces in the respective target magnetic tapes; and storing the p data blocks and the q parity blocks in the first physical storage spaces. The p data blocks and the q parity blocks correspond to different target magnetic tapes, and offsets of the first physical storage spaces corresponding to the p data blocks and the q parity blocks are the same.

### CROSS-REFERENCE TO RELATED APPLICATIONS

This application is a National Stage of International Application No. PCT/CN2024/078628, and filed on Feb. 26, 2024, which claims priority to Chinese Patent Application No. 202310209425.2, filed with the China National Intellectual Property Administration on Mar. 2, 2023 and entitled “DATA STORAGE METHOD, DEVICE, STORAGE MEDIUM, AND SYSTEM”. The disclosures of the aforementioned applications are hereby incorporated by reference in their entireties.

### TECHNICAL FIELD

The present disclosure relates to the field of Internet technologies, and in particular, to a data storage method, a device, a storage medium, and a system.

### BACKGROUND

A hard disk drive and a magnetic tape are two types of storage media that are regularly used at present. Currently, the hard disk drive is mainly used for online storage, and the magnetic tape pays more attention to offline storage. People are accustomed to referring to data with a high access frequency as hot data, and data with a low access frequency as cold data. The delay requirement of the cold data is low, while the amount thereof is large. Typical scenarios of the cold data include data backup, disaster recovery, social media, various types of movie and audio recording, and the like. The magnetic tape is often used for archiving and storage of the cold data due to its features of high storage density, low costs, long-time storage stability, a low bit error rate, and no power consumption during non-use.

However, the magnetic tape also has an attribute different from that of the hard disk drive. For example, the magnetic tape can be read/written only after being loaded by a robot arm into a magnetic tape drive. In addition, although the magnetic tape can provide high performance during sequential reading/writing, seek time is very long, to be specific, the magnetic tape is slowly rotated, at slow rotation speed, to physical storage space corresponding to data that currently needs to be read, and this may take up to tens of seconds. These features of the magnetic tape cause difficulties in using the magnetic tape efficiently. In addition, a case in which data is damaged due to reasons such as medium damage of a specific length may also occur in the magnetic tape. Therefore, it is also practical to improve data storage reliability.

### SUMMARY

Embodiments of the present disclosure provide a data storage method, a device, a storage medium, and a system, to improve data storage efficiency and data storage reliability in a magnetic tape.

According to a first aspect, an embodiment of the present disclosure provides a data storage method, where the method includes:
determining, in response to a data write task, a target magnetic tape group from a plurality of magnetic tape groups, where a quantity of magnetic tapes included in the target magnetic tape group is a first quantity that is set based on erasure coding configuration information;
obtaining a group of data blocks corresponding to the data write task and generating a group of parity blocks based on the group of data blocks, where the group of data blocks includes a second quantity of data blocks, the group of parity blocks includes a third quantity of parity blocks, and the first quantity is a sum of the second quantity and the third quantity;
determining, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, where each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks; and
storing the group of data blocks to the first physical storage spaces in the target magnetic tapes corresponding to the group of data blocks and storing the group of parity blocks to the first physical storage spaces in the target magnetic tapes corresponding to the group of parity blocks.

According to a second aspect, an embodiment of the present disclosure provides a data storage apparatus, where the apparatus includes:
a determining module, configured to determine, in response to a data write task, a target magnetic tape group from a plurality of magnetic tape groups, where a quantity of magnetic tapes included in the target magnetic tape group is a first quantity that is set based on erasure coding configuration information;
an obtaining module, configured to obtain a group of data blocks corresponding to the data write task and generate a group of parity blocks based on the group of data blocks, where the group of data blocks includes a second quantity of data blocks, the group of parity blocks includes a third quantity of parity blocks, and the first quantity is a sum of the second quantity and the third quantity;
a mapping module, configured to determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, where each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks; and
a read/write module, configured to store the group of data blocks to the first physical storage spaces in the target magnetic tapes corresponding to the group of data blocks and store the group of parity blocks to the first physical storage spaces in the target magnetic tapes corresponding to the group of parity blocks.

According to a third aspect, an embodiment of the present disclosure provides an electronic device, including: a memory, a processor, and a communication interface, where the memory stores an executable code which, when executed by the processor, causes the processor to perform the data storage method according to the first aspect.

According to a fourth aspect, an embodiment of the present disclosure provides a non-transitory machine readable storage medium, where the non-transitory machine readable storage medium stores an executable code which, when executed by a processor of an electronic device, causes the processor to implement at least the data storage method according to the first aspect.

According to a fifth aspect, an embodiment of the present disclosure provides a data storage system, including:
a management server, a plurality of magnetic tapes, and a plurality of magnetic tape drives;
where the management server is configured to perform at least the data storage method according to the first aspect.

In this embodiment of the present disclosure, in a process of performing data storage by using a magnetic tape, erasure coding is used to ensure data reliability, a plurality of magnetic tapes are divided into magnetic tape groups based on erasure coding configuration information, and a quantity of magnetic tapes included in each magnetic tape group is a first quantity n that is set based on the erasure coding configuration information.

For a data storage process, when data generated by an application system needs to be stored in a magnetic tape, a target magnetic tape group is selected from a plurality of magnetic tape groups randomly or based on a load. In addition, a second quantity p of sequentially generated data blocks may be obtained, and a third quantity q of parity blocks are generated based on the p data blocks and an erasure coding algorithm. The foregoing first quantity n=p+q. In other words, the erasure coding configuration information is: total data blocks n=p original data blocks+q parity blocks, where a size of each data block is a preset value.

In view of this, n to-be-stored blocks are generated, including: a group of data blocks including the p data blocks and a group of parity blocks including the q parity blocks. In addition, a quantity of magnetic tapes included in the target magnetic tape group is n. Therefore, the n to-be-stored blocks may be stored in the n magnetic tapes included in the target magnetic tape group. Specifically, from the target magnetic tape group, target magnetic tapes respectively corresponding to the p data blocks and respectively corresponding to the q parity blocks and first physical storage spaces in the respective corresponding target magnetic tapes are determined. In other words, the n to-be-stored blocks are respectively stored in the n magnetic tapes, each magnetic tape stores only one block therein, and offsets of physical storage spaces corresponding to the n to-be-stored blocks in the respective corresponding target magnetic tapes, for example, 10th physical storage spaces in magnetic tapes, are the same, where a size of a physical storage space is equivalent to a size of the foregoing data block.

Based on the foregoing solution, since the p data blocks and the corresponding q parity blocks are stored in the physical storage spaces with the same offset in magnetic tapes in the same target magnetic tape group, the magnetic tapes in the target magnetic tape group are basically in a same progress, to reduce waiting time caused by different progresses in different magnetic tapes, thereby reducing addressing overheads and improving storage efficiency. In addition, based on the erasure coding algorithm, when q blocks in the n blocks are faulty, the q blocks may also be repaired based on remaining p blocks, thereby ensuring data storage reliability. In addition, allocation by using erasure coding is in a range of only one magnetic tape group, so that a quantity of magnetic tapes needed for repairing can be reduced. Since the magnetic tapes needed for repairing are limited to a range of n magnetic tapes in a same magnetic tape group, a quantity of to-be-read magnetic tapes is reduced, thereby optimizing a scheduling frequency of a robot arm.

### BRIEF DESCRIPTION OF DRAWINGS

To describe the technical solutions in embodiments of the present disclosure more clearly, the following briefly describes the accompanying drawings required for describing embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of a data storage system according to an embodiment of the present disclosure.

FIG. 2 is a schematic diagram of a data storage result in a magnetic tape group according to an embodiment of the present disclosure.

FIG. 3 is a flow chart of a data storage method according to an embodiment of the present disclosure.

FIG. 4 is a schematic diagram of an index information storage method according to an embodiment of the present disclosure.

FIG. 5 is a flow chart of a data storage method according to an embodiment of the present disclosure.

FIG. 6 is a flow chart of a data storage method according to an embodiment of the present disclosure.

FIG. 7 is a flow chart of a data storage method according to an embodiment of the present disclosure.

FIG. 8 is a schematic diagram of mapping relationships between magnetic tape read/write management units and physical storage spaces according to an embodiment of the present disclosure.

FIG. 9 is a flow chart of a data storage method according to an embodiment of the present disclosure.

FIG. 10 is a schematic diagram of a data copying process according to an embodiment of the present disclosure.

FIG. 11 is a schematic diagram of a task execution process according to an embodiment of the present disclosure.

FIG. 12 is a schematic structural diagram of a data storage apparatus according to an embodiment of the present disclosure.

FIG. 13 is a schematic structural diagram of an electronic device according to an embodiment of the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are merely some embodiments of the present disclosure rather than all of the embodiments. All other embodiments obtained by a person of ordinary skill in the art based on embodiments of the present disclosure without creative efforts shall fall in the protection scope of the present disclosure. In addition, a sequence of steps in the following method embodiments is merely an example, and is not a strict limitation.

It should be noted that user information (including but not limited to user equipment information, user personal information, and the like) and data (including but not limited to data used for analysis, stored data, displayed data, and the like) in embodiments of the present disclosure are all information and data authorized by a user or fully authorized by all parties, and collection, use and processing of relevant data need to comply with relevant laws, regulations and standards of relevant countries and regions, and a corresponding operation entry is provided for the user to select authorization or rejection.

First, some concepts in the embodiments of the present disclosure are explained and described.

Erasure coding (EC) is a data protection method with coding fault tolerance. The EC not only has functions of identifying and correcting an error code, but also may delete information that cannot be corrected when the error code exceeds a correction range. A basic structure of the EC is: total data blocks n=p original data blocks+q parity blocks, that is, n=p+q, a quantity of allowed faults is q, including an original data block and a parity block.

A magnetic tape drive is a magnetic tape reading/writing tool. A magnetic tape needs to be loaded into the magnetic tape drive to be read/written.

A magnetic tape library includes a plurality of magnetic tape drives, a plurality of magnetic tape slots, and a robot arm, and the robot arm may automatically remove and install the magnetic tape.

A scheduling domain (SD) is a combination of a management server and a group of magnetic tapes and magnetic tape drives. Generally, a quantity of the magnetic tape drives is far less than that of the magnetic tapes, and the magnetic tape in the SD can only be loaded to the magnetic tape drive in the SD.

A magnetic tape group is a group of magnetic tapes obtained by division based on EC configuration information. The EC configuration information is: n=p+q above, in other words, one magnetic tape group includes n magnetic tapes. The corresponding p data blocks and q parity blocks for performing EC calculation once are stored only in magnetic tapes in one magnetic tape group without performing calculation across magnetic tape groups, and it is ensured that one block is only in one magnetic tape. Such a constraint may reduce a quantity of magnetic tapes in data repairing, to be specific, limit a quantity of magnetic tapes needed for data repairing to a quantity of magnetic tapes included in one magnetic tape group.

A magnetic tape read/write management unit is a logical concept used for managing a storage space of the magnetic tape group, and is not an actual physical storage medium. In short, a physical storage space of the magnetic tape group is mapped to a plurality of logical magnetic tape read/write management units, to provide a read/write service for the external. The concept of the magnetic tape read/write management unit is introduced to facilitate data read/write processing on magnetic tapes in the magnetic tape group. One magnetic tape read/write management unit includes p logical storage spaces, the p logical storage spaces are mapped to physical storage spaces with the same offset in p magnetic tapes in a magnetic tape group, and an address range of one physical storage space is set based on a size of a data block.

A linear tape file system (LTFS) is a file system for a single magnetic tape, where a magnetic tape is divided into a data area and an index area, and in the index area, file system information and metadata are maintained for query. After data is written, an index needs to be updated for the writing to be successful. Since the index area is usually at a head of the magnetic tape, large magnetic tape seeking overheads are caused during performing a data read/write operation. Specifically, when data needs to be written, the magnetic tape needs to be controlled to be rotated to a write location in the data area. After the data is written successfully, it is necessary to rewind to the index area at the head, and metadata corresponding to data that has just been written is written into the index area. When data is read, the magnetic tape needs to be first rotated to the index area, to query for a storage location corresponding to the to-be-read data in the data area from the index area, and then the magnetic tape is rotated to the storage location, to read the corresponding data. It can be learned that according to such an index and data organization manner, the magnetic tape may be frequently rotated in different directions in a data reading/writing process, consuming large addressing time.

Features of the magnetic tape allow the magnetic tape to be suitable for an application scenario of cold data archiving. However, due to limitations of the magnetic tape (for example, a robot arm needs to be frequently scheduled to load different magnetic tapes into the magnetic tape drive for reading/writing and seek time is long) and a requirement of ensuring data reliability, in embodiments of the present disclosure, performance of the magnetic tape is improved by introducing an effective scheduling capability and allocation strategy, and a storage architecture in which an index is separated from data. The following describes a solution of using a magnetic tape for data storage according to an embodiment of the present disclosure.

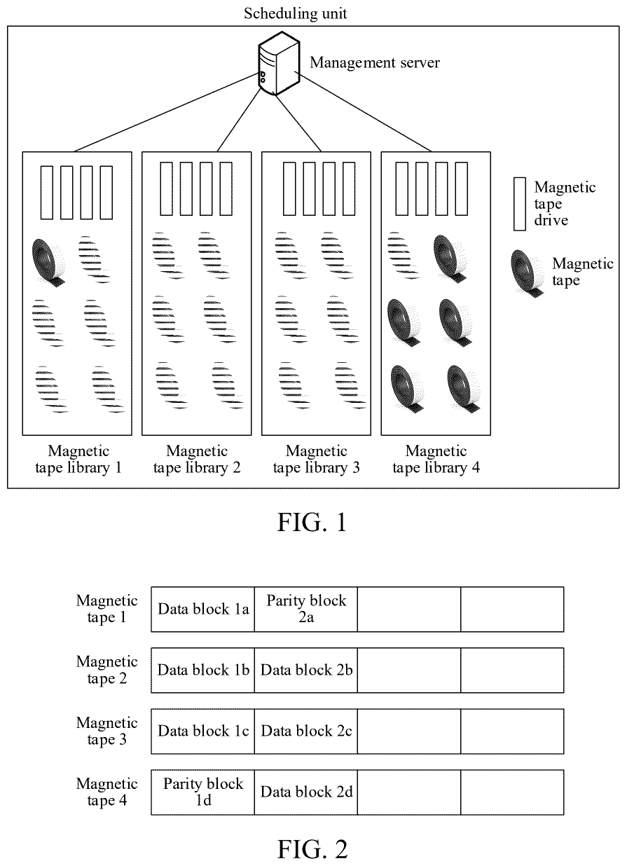

FIG. 1 is a schematic diagram of a data storage system according to an embodiment of the present disclosure. As shown in FIG. 1, the system includes: a management server, a plurality of magnetic tapes, and a plurality of magnetic tape drives.

As shown in FIG. 1, the plurality of magnetic tapes and the plurality of magnetic tape drives may belong to a same SD, and each SD may include a management server. Actually, the data storage system may include a plurality of SDs.

During actual application, for example, different SDs may be configured for different data storage demanders. The data storage demanders may be one or more application systems corresponding to a user that has a large amount of data that needs to be archived and stored by using a magnetic tape.

Running logic of different SDs is independent of each other, and does not interfere with each other, to improve availability of the data storage system. Therefore, for ease of description, in this embodiment, only one SD included in the data storage system is used as an example for description.

The SD is a combination of a management server and a group of magnetic tapes and magnetic tape drives. Actually, a quantity of the magnetic tape drives is greater than that of the magnetic tapes. The management server in the SD manages only a magnetic tape and a magnetic tape drive included in the SD.

In an embodiment, as shown in FIG. 1, several magnetic tape libraries (for example, a magnetic tape library 1 to a magnetic tape library 4 shown in FIG. 1) may be defined as one SD, in other words, resources such as magnetic tapes and magnetic tape drives included in the several magnetic tape libraries are defined as belonging to one SD. However, actually, this is not limited thereto. For example, some magnetic tapes and magnetic tape drives may be respectively divided from a plurality of magnetic tape libraries to form an SD, or some magnetic tapes and magnetic tape drives may be divided from a magnetic tape library to form an SD.

The SD is a fault domain of a service. As described above, one SD may include a management server, a plurality of magnetic tapes and a plurality of magnetic tape drives. Therefore, one SD is actually a storage management system. The management server runs service programs such as a service program providing a magnetic tape group allocation strategy and a service program scheduling a data read/write task, to manage the magnetic tapes and the magnetic tape drives in the SD. If these service programs are abnormal or the management server is abnormal, it means that the SD cannot work normally, however, data stored in each magnetic tape in the SD before the abnormality is not affected. Therefore, the SD is the fault domain of the service.

In embodiments of the present disclosure, functions of the management server may mainly include two aspects: one is magnetic tape group division and the other is data read/write task scheduling.

For the magnetic tape group division, a plurality of magnetic tapes are divided into a plurality of magnetic tape groups, where a quantity of magnetic tapes included in each magnetic tape group is a first quantity that is set based on the EC configuration information.

A conventional manner for providing data security is a multi-copy manner (for example, a three-copy manner). However, the multi-copy manner results in a large amount of additional data that needs to be stored, reducing storage efficiency. In embodiments of the present disclosure, to improve data security and storage efficiency, an EC manner is used. As described above, assuming that the EC configuration information is: n=p+q, where p is a quantity of data blocks, and q is a quantity of parity blocks, a quantity of magnetic tapes included in one magnetic tape group is a first quantity that is equal to n. In other words, the EC is implemented inside only one magnetic tape group, without being implemented cross different magnetic tape groups.

During magnetic tape group division, the management server may traverse magnetic tapes that are in the current SD and on which magnetic tape group allocation is not performed, and select n magnetic tapes from the magnetic tapes to form a magnetic tape group.

There is usually one faulty magnetic tape in one magnetic tape library. Therefore, when the SD includes magnetic tapes in a plurality of magnetic tape libraries, one magnetic tape may be selected from one magnetic tape library to be added to one magnetic tape group. For example, if EC configuration is: p+q=3+1, one magnetic tape may be selected from each magnetic tape library to be added to one magnetic tape group, and one magnetic tape group includes four magnetic tapes.

The magnetic tape group is a fault domain of data. One magnetic tape group includes the n magnetic tapes, and data is stored in each magnetic tape. If a magnetic tape is faulty, stored data is damaged. Therefore, the magnetic tape group is the fault domain of data.

In a magnetic tape archiving system, magnetic tape scheduling performed by a robot arm and magnetic tape addressing are expensive operations. Based on this, in the solutions provided in embodiments of the present disclosure, the following two objectives are mainly optimized by using the functions provided by the management server.
Optimization objective 1: in a single-disk magnetic tape fault, a quantity of magnetic tapes needed for repairing is reduced, and a scheduling frequency of a robot arm is optimized.
Optimization objective 2: when a partial length of a single-disk magnetic tape is unreadable, repairing data is located at a same location in another magnetic tape. In this way, these magnetic tapes are basically at a same progress, thereby reducing waiting time caused by different progresses in different magnetic tapes.

During actual application, a common fault model in a magnetic tape group is that a single-disk magnetic tape is faulty. Therefore, in embodiments of the present disclosure, a common single-disk magnetic tape fault scenario is used for description.

Actually, the foregoing magnetic tape group division strategy provides premise and guarantee to achieve the foregoing optimization objective 1. Since data storage is performed based on EC in one magnetic tape group, each group of p data blocks and q parity blocks obtained based on the EC are stored only in each magnetic tape in one magnetic tape group. In other words, based on the EC, physical storage spaces in magnetic tapes are allocated in only one magnetic tape group. If the physical storage spaces are not allocated inside the magnetic tape group based on the EC, the physical storage spaces may be allocated in another external magnetic tape based on the EC. A feature of the data repairing based on the EC is that data of all magnetic tapes in the EC needs to be read. Therefore, a quantity of magnetic tapes in the repairing is greater than that of magnetic tapes that need to be read when physical storage space allocation is performed in only one magnetic tape group, namely, a quantity n of magnetic tapes included in one magnetic tape group. In other words, when the EC manner is implemented in a magnetic tape group, if a magnetic tape therein has a data block fault, only related repairing data in other (n-1) magnetic tapes needs to be read, to limit a quantity of magnetic tapes needed for repairing in a range of one magnetic tape group. In this way, scheduling of the robot arm is in the range of only one magnetic tape group, in other words, scheduling objects of the robot arm are only n magnetic tapes in the magnetic tape group, thereby implementing optimization of the scheduling frequency of the robot arm.

However, for the optimization objective 2, based on achieving the optimization objective 1 by using the allocation strategy of the magnetic tape group, the optimization objective 2 may be achieved by scheduling physical storage spaces of p data blocks and q parity blocks generated each time in magnetic tapes in the magnetic tape group. Specifically, if offsets of the physical storage spaces of the p data blocks and q parity blocks in magnetic tapes in the magnetic tape group are the same, and one block (a data block and a parity block) is stored in one magnetic tape, the optimization objective 2 can be implemented.

For ease of understanding, taking EC configuration is: 3+1 as an example, and the optimization objective 2 is schematically described with reference to FIG. 2.

In FIG. 2, it is assumed that to-be-stored data generated on a user side includes a data block 1a, a data block 1b, and a data block 1c that are sequentially generated. Data block division may be performed on the to-be-stored data received from the user side based on a set size of a data block. Based on the foregoing EC configuration information, a parity block is calculated based on every three data blocks, so that a parity block 1d is calculated based on the foregoing three data blocks. As shown in FIG. 2, the four blocks are respectively stored in four magnetic tapes shown in this figure, and offsets of physical storage spaces in the four magnetic tapes are consistent. FIG. 2 shows a case in which an offset is equal to 0.

Then, assuming that generated three data blocks are a data block 2b, a data block 2c, and a data block 2d, a parity block 2a is calculated based on the three data blocks, and the four blocks are respectively stored in physical storage spaces with offsets being equal to 1 in the four magnetic tapes, and so on. It should be noted that actually, an offset, corresponding to a physical storage space obtained by adding the set size of the data block to a start address of a physical storage space with an offset being equal to 0, is referred to as offset=1.

Actually, specifications of magnetic tapes in one magnetic tape group are usually the same. For example, total lengths and rotational speeds of the magnetic tapes are basically consistent. Based on the foregoing storage scheduling strategy, four blocks associated with each other may be respectively stored in physical storage spaces having a same offset in the four magnetic tapes. In this way, progresses of the four magnetic tapes are basically consistent. For example, when it is attempted to read four blocks with offsets being equal to 1 at a specific moment, the four magnetic tapes may be controlled to be rotated at a same speed and in same rotation time to synchronously arrive at the physical storage spaces with offsets being equal to 1, to read the four blocks. In this way, compared with a situation in which different magnetic tapes have different progresses, and therefore a magnetic tape arrives at the location quickly but needs to wait for another magnetic tape to be rotated to the location for longer time to read data, there are lower addressing overheads due to no additional waiting time being needed.

The foregoing briefly describes how the management server implements the foregoing two optimization objectives. A working process of the management server is specifically described below with reference to the following embodiments.

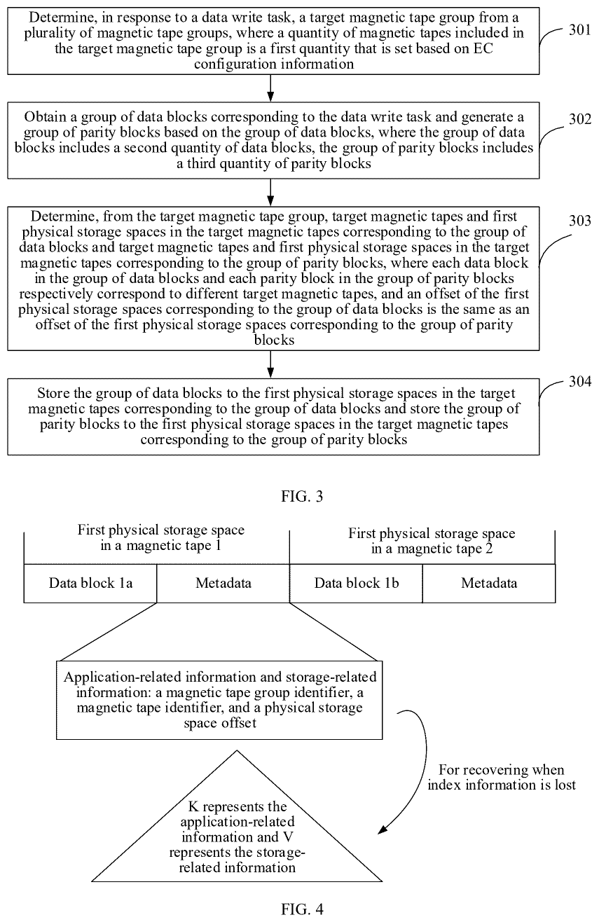

FIG. 3 is a flow chart of a data storage method according to an embodiment of the present disclosure. The method may be performed by the management server described above. As shown in FIG. 3, the method includes the following steps.
301: determine, in response to a data write task, a target magnetic tape group from a plurality of magnetic tape groups, where a quantity of magnetic tapes included in the target magnetic tape group is a first quantity that is set based on EC configuration information.
302: obtain a group of data blocks corresponding to the data write task and generate a group of parity blocks based on the group of data blocks, where the group of data blocks includes a second quantity of data blocks, and the group of parity blocks includes a third quantity of parity blocks.
303: determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, where each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks.
304: store the group of data blocks to the first physical storage spaces in the target magnetic tapes corresponding to the group of data blocks and store the group of parity blocks to the first physical storage spaces in the target magnetic tapes corresponding to the group of parity blocks.

The EC configuration information indicates to generate the third quantity of parity blocks based on the second quantity of data blocks, so that the first quantity is a sum of the second quantity and the third quantity. As described above, the EC configuration information is: n=p+q, p is a quantity of data blocks, namely, the second quantity, q is a quantity of parity blocks, namely, the third quantity, and n is the sum of the p and q, namely, the first quantity.

A data writing process is first described in this embodiment.

When an external application system (such as a video server or an Internet of Things system) triggers the data write task to a management server, then data that needs to be stored in a magnetic tape will be sent to the management server.

As described above, the management server is pre-allocated by a cloud service provider to the application system, and may be a management server in an SD allocated to the application system. The management server performs magnetic tape group division on a plurality of magnetic tapes in advance to obtain a plurality of magnetic tape groups. Each magnetic tape group includes n magnetic tapes.

In response to the data write task currently triggered by the application system, the management server determines the target magnetic tape group from the plurality of magnetic tape groups corresponding to the application system, so as to store the to-be-stored data corresponding to the data write task. Where the management server may randomly select one magnetic tape group from the plurality of magnetic tape groups as the target magnetic tape group, or may select, based on remaining storage capacities of the magnetic tape groups, one magnetic tape group having a large quantity of remaining storage capacities as the target magnetic tape group.

Data block size information is pre-configured in the management server. Based on this, data block division is performed on the to-be-stored data transmitted by the application system. When p data blocks are generated, q parity blocks are generated based on an EC algorithm and the p data blocks. The p data blocks are the foregoing group of data blocks, the q parity blocks are the foregoing group of parity blocks, and p+q=n.

Then, from the target magnetic tape group, target magnetic tapes respectively corresponding to the p data blocks and respectively corresponding to the q parity blocks as well as first physical storage spaces in the respective corresponding target magnetic tapes are determined. Where the p data blocks and the q parity blocks respectively correspond to different target magnetic tapes, and offsets of the first physical storage spaces respectively corresponding to the p data blocks and respectively corresponding to the q parity blocks are the same. For example, assuming that the p data blocks are a data block 1a, a data block 1b, and a data block 1c, the q parity blocks are the parity block 1d shown in FIG. 2, and the target magnetic tape group includes the four magnetic tapes shown in FIG. 2, as shown in FIG. 2, the four blocks are respectively stored in the four magnetic tapes shown in this figure, and offsets of first physical storage spaces in the four magnetic tapes are consistent, where offset=0. Where a target magnetic tape corresponding to the data block 1a is a magnetic tape 1, a target magnetic tape corresponding to the data block 1b is a magnetic tape 2, a target magnetic tape corresponding to the data block 1c is a magnetic tape 3, and a target magnetic tape corresponding to the parity block 1d is a magnetic tape 4.

After determining the first physical storage spaces respectively corresponding to the p data blocks and respectively corresponding to the q parity blocks in the target magnetic tape group, the management server may control a robot arm to load each magnetic tape in the target magnetic tape group to a magnetic tape drive, control each magnetic tape to be rotated to a length location of the first physical storage space, and write the p data blocks and the q parity blocks into the corresponding first physical storage spaces by using the magnetic tape drive.

Based on the foregoing solution, since the p data blocks and the corresponding q parity blocks are stored in the physical storage spaces that have the same offset and that are in magnetic tapes in the same target magnetic tape group, the magnetic tapes in the target magnetic tape group are basically in a same progress, to reduce waiting time caused by different progresses in different magnetic tapes, thereby reducing addressing overheads and improving storage efficiency. In addition, based on the erasure coding algorithm, when q blocks in the n blocks are faulty, the q blocks may also be repaired based on remaining p blocks, thereby ensuring data storage reliability. In addition, allocation by using erasure coding is in a range of only one magnetic tape group, so that a quantity of magnetic tapes needed for repairing can be reduced. Since the magnetic tapes needed for repairing are limited to a range of n magnetic tapes in a same magnetic tape group, a quantity of to-be-read magnetic tapes is reduced, thereby optimizing a scheduling frequency of a robot arm.

In addition, after the p data blocks and the corresponding q parity blocks are written into the corresponding first physical storage spaces, index information corresponding to each data block is generated and stored. Specifically, index information respectively corresponding to the p data blocks is generated, and the index information respectively corresponding to the p data blocks is stored in an index system, for use during data block query. In addition, the index information respectively corresponding to the p data blocks is correspondingly stored in the first physical storage spaces respectively corresponding to the p data blocks, to recover abnormal index information when the abnormal index information exists in the index system.

Index information corresponding to a data block is also referred to as metadata of the data block, and may include application-related information and storage-related information that correspond to the data block. Where the application-related information includes, for example, an application name, a data type, and data generation time. The storage-related information includes, for example, an identifier of a magnetic tape group in which the data block is located, an identifier of a magnetic tape in which the data block is stored, an identifier of a physical storage space, or an offset corresponding to the physical storage space.

As shown in FIG. 4, a data block and corresponding metadata thereof are stored in a corresponding physical storage space together. For example, as shown in this figure, a data block 1a and metadata thereof are stored in a first physical storage space of a magnetic tape 1, and a data block 1b and metadata thereof are stored in a first physical storage space of a magnetic tape 2. In addition, an index system may be deployed in a management server or another device, and index information of a data block is stored in a key-value pair (K-V) manner, where K represents application-related information and V represents storage-related information.

It should be noted that in a data reading process, an external index system is used. The metadata stored in the magnetic tape is used only for restoring the index system when metadata corresponding to a data block in the index system is abnormal, for example, the metadata is lost or damaged.

For example, when the data block 1a is read, the index system is queried based on application-related information provided by the application system to determine storage-related information of the data block. If the storage-related information is successfully obtained, the data block 1a is read from the first physical storage space of the magnetic tape 1 in the corresponding target magnetic tape group based on the storage-related information. If failing to obtain the storage-related information, the target magnetic tape group is queried to determine metadata corresponding to the application-related information, and the metadata is copied into the index system, to recover corresponding metadata in the index system.

In a conventional LTFS, an index and data are stored in one magnetic tape at the same time. The index is located at a head of the magnetic tape, and the data is at the rear of the magnetic tape. Since magnetic tape addressing is as slow as tens of seconds, and if the index is also inside the magnetic tape, overheads are very large due to involved frequent rotation operations of the magnetic tape, causing bad impact on performance and life of the magnetic tape. In embodiments of the present disclosure, the external index system is used to store index information of a data block in a manner of separating data from an index. Since a storage space occupied by the index information is small, costs are controllable. In this way, frequent rotation operations on the magnetic tape are reduced.

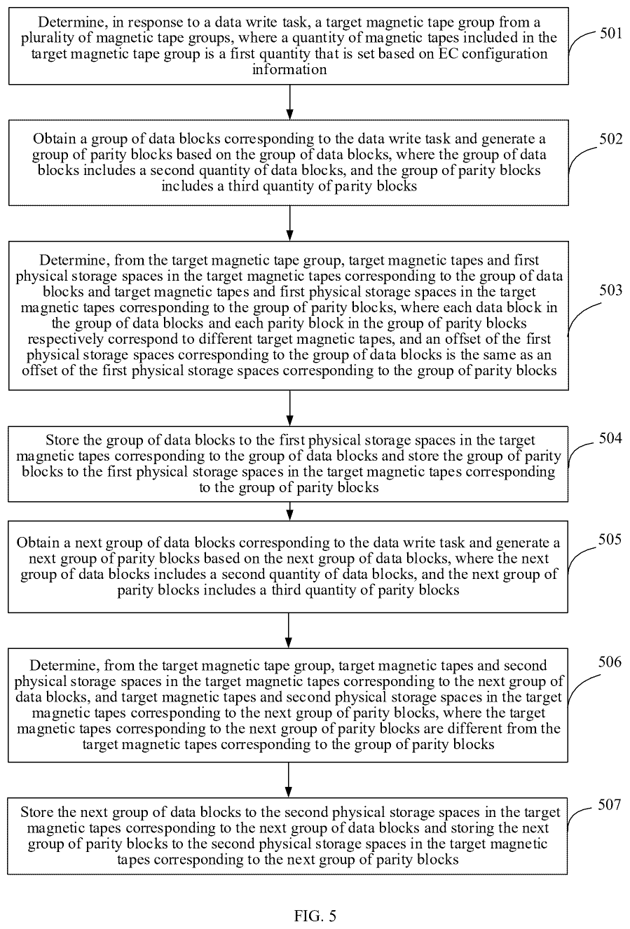

FIG. 5 is a flow chart of a data storage method according to an embodiment of the present disclosure. The method may be performed by the management server described above. As shown in FIG. 5, the method includes the following steps.
501: determine, in response to a data write task, a target magnetic tape group from a plurality of magnetic tape groups, where a quantity of magnetic tapes included in the target magnetic tape group is a first quantity that is set based on EC configuration information.
502: obtain a group of data blocks corresponding to the data write task and generate a group of parity blocks based on the group of data blocks, where the group of data blocks includes a second quantity of data blocks, and the group of parity blocks includes a third quantity of parity blocks.
503: determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, where each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks.
504: store the group of data blocks to the first physical storage spaces in the target magnetic tapes corresponding to the group of data blocks and store the group of parity blocks to the first physical storage spaces in the target magnetic tapes corresponding to the group of parity blocks.
505: obtain a next group of data blocks corresponding to the data write task and generate a next group of parity blocks based on the next group of data blocks, where the next group of data blocks includes a second quantity of data blocks, and the next group of parity blocks includes a third quantity of parity blocks.
506: determine, from the target magnetic tape group, target magnetic tapes and second physical storage spaces in the target magnetic tapes corresponding to the next group of data blocks, and target magnetic tapes and second physical storage spaces in the target magnetic tapes corresponding to the next group of parity blocks, where the target magnetic tapes corresponding to the next group of parity blocks are different from the target magnetic tapes corresponding to the group of parity blocks.
507: store the next group of data blocks to the second physical storage spaces in the target magnetic tapes corresponding to the next group of data blocks and storing the next group of parity blocks to the second physical storage spaces in the target magnetic tapes corresponding to the next group of parity blocks.

This embodiment of the present disclosure is mainly used to describe a difference between a storage process of a former group of data blocks and a latter group of data blocks and a difference between a storage process of a former group of parity blocks and a latter group of parity blocks. The main differences lie in distribution of physical storage spaces of parity blocks. In summary, a general principle is as follows: the parity blocks are stored in different magnetic tapes in a distribution manner. For example, in an implementation physical storage spaces for the parity blocks are allocated in the magnetic tapes in a round-robin manner.

Descriptions are provided by using an example with reference to FIG. 2. It is assumed that the foregoing group of data blocks and the group of parity blocks are the data block 1a, the data block 1b, the data block 1c, and the parity block 1d shown in FIG. 2, and received to-be-stored data is divided into the next group of data blocks shown in FIG. 2: the data block 2b, the data block 2c, and the data block 2d. A next group of parity blocks, namely, the parity block 2a, is generated based on the three data blocks.

Based on a feature of sequential storage of the magnetic tapes, after the data block 1a, the data block 1b, the data block 1c, and the parity block 1d are respectively stored in the first physical storage spaces with offsets being equal to 0 in the magnetic tape 1 to the magnetic tape 4 in the manner shown in FIG. 2, according to a rule of sequential storage of parity blocks in the magnetic tape 1 to the magnetic tape 4 in a round-robin manner, since the parity block 1d is stored in the magnetic tape 4, the next group of parity blocks 2a is stored in the magnetic tape 1 in a round-robin manner. Therefore, the parity block 2a is stored in a second physical storage space with offset being equal to 1 in the magnetic tape 1, and the data block 2b, the data block 2c, and the data block 2d that are related to the parity block 2a are respectively stored in second physical storage spaces with offsets being equal to 1 in the magnetic tapes 2 to 4.

Similarly, when a next subsequent group of data blocks and parity blocks are generated, the parity blocks in this case are to be stored in the magnetic tape 2.

The foregoing storage of the parity blocks in the plurality of magnetic tapes in a round-robin manner is merely an optional manner. Actually, after the p data blocks and the corresponding q parity blocks are obtained, the p data blocks and the q parity blocks may alternatively be randomly allocated to the n magnetic tapes in the target magnetic tape group, and one magnetic tape corresponds to one block, provided that offsets of physical storage spaces of the n blocks in the magnetic tapes are the same.

A reason for avoiding concentrated storage of the parity blocks in a magnetic tape is that the parity blocks are generally read only when data repairing is needed. If all parity blocks are concentrated in one magnetic tape, the magnetic tape has a very low probability of being read. Consequently, performance of magnetic tapes in a same magnetic tape group gradually differs apparently, casing a bad impact on overall performance.

It is mentioned above that existence of the parity block may facilitate data repairing. A data repairing process is described below.

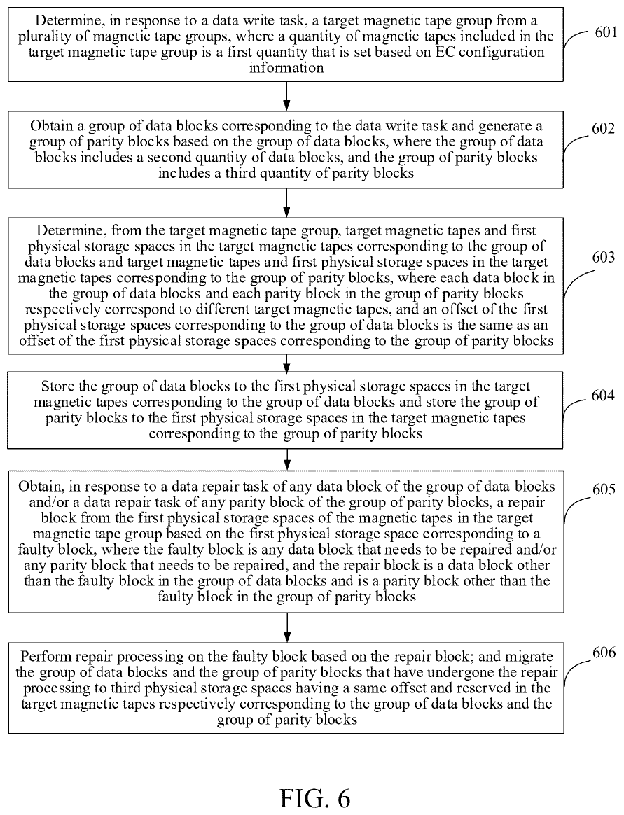

FIG. 6 is a flow chart of a data storage method according to an embodiment of the present disclosure. The method may be performed by the management server described above. As shown in FIG. 6, the method includes the following steps.
601: determine, in response to a data write task, a target magnetic tape group from a plurality of magnetic tape groups, where a quantity of magnetic tapes included in the target magnetic tape group is a first quantity that is set based on EC configuration information.
602: obtain a group of data blocks corresponding to the data write task and generate a group of parity blocks based on the group of data blocks, where the group of data blocks includes a second quantity of data blocks, and the group of parity blocks includes a third quantity of parity blocks.
603: determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, where each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks.
604: store the group of data blocks to the first physical storage spaces in the target magnetic tapes corresponding to the group of data blocks and store the group of parity blocks to the first physical storage spaces in the target magnetic tapes corresponding to the group of parity blocks.
605: obtain, in response to a data repair task of any data block of the group of data blocks and/or a data repair task of any parity block of the group of parity blocks, a repair block from the first physical storage spaces of the magnetic tapes in the target magnetic tape group based on the first physical storage space corresponding to a faulty block, where the faulty block is any data block that needs to be repaired and/or any parity block that needs to be repaired, and the repair block is a data block other than the faulty block in the group of data blocks and is a parity block other than the faulty block in the group of parity blocks.
606: perform repair processing on the faulty block based on the repair block; and migrate the group of data blocks and the group of parity blocks that have undergone the repair processing to third physical storage spaces having a same offset and reserved in the target magnetic tapes respectively corresponding to the group of data blocks and the group of parity blocks.

In this embodiment, an example in which the foregoing group of data blocks and parity blocks are the data block 1a, the data block 1b, the data block 1c, and the parity block 1d is used for description.

During actual application, each time a data block and a parity block are written into a magnetic tape, a corresponding cyclic redundancy check (CRC) code may be generated, and the data block, the parity block, and the corresponding CRC code are stored in a corresponding physical storage space together. Therefore, when the data block 1a, the data block 1b, the data block 1c, and the parity block 1d are written into the first physical storage spaces in the magnetic tapes 1 to 4 as shown in FIG. 2, each block is associated with a corresponding CRC code.

Verification may be periodically performed on each data block and each parity block that are stored in the target magnetic tape group. To be specific, each data block and each parity block that are stored are read, and a CRC code is recalculated based on read content. Using the data block 1a as an example, if a CRC code 2 calculated in this case based on the read data block 1a is different from a CRC code 1 corresponding to previous writing of the data block 1a, it indicates that data of the data block 1a is damaged, and a data repair task for the data block 1a is triggered. In this case, the data block 1a is a faulty block.

In addition, for example, when the application system triggers reading of the data block 1a, if it is finally found that the data block 1a cannot be successfully read, for example, a magnetic tape length corresponding to the corresponding first physical storage space is faulty, the data repair task for the data block 1a is also triggered. In this case, the data block 1a is a faulty block.

It is determined that the data block 1a is located in the first physical storage space with an offset being equal to 0 in the magnetic tape 1, and then the data block 1b, the data block 1c, and the parity block 1d, that are respectively read from the first physical storage spaces with offsets being equal to 0 in the remaining magnetic tapes 2 to 4, are repair blocks used for repairing the data block 1a. Based on an EC algorithm, the data block 1b, the data block 1c, and the parity block 1d may be used to generate a new data block 1a, and a previously faulty data block 1a is replaced with the new data block 1a, so that repair of the data block 1a is completed.

Continuing from the foregoing optimization objective 2, it may be learned from an example in this embodiment that it is assumed that the four magnetic tapes in the current target magnetic tape group are rotated to locations with offsets being equal to 10. Since the associated data block 1a, data block 1b, data block 1c, and parity block 1d are all located at locations with offsets being equal to 0 in the magnetic tapes in the target magnetic tape group, the four magnetic tapes in the target magnetic tape group may be rotated together, to arrive at the locations with offsets being equal to 0 simultaneously based on a same rotation speed and same rotation time. Corresponding repairing data is read to complete repair processing, without additional waiting time.

In addition, actually, damage to the data block 1a may be caused by a fault in a segment of magnetic tape corresponding to the first physical storage space in the magnetic tape 1. Therefore, after the foregoing repair processing is completed, p data blocks and q parity blocks that have undergone the repair processing are migrated to third physical storage spaces having a same offset and reserved in respectively corresponding target magnetic tapes.

The management server may pre-reserve a section of physical storage spaces, for example, 50 physical storage spaces with offsets being from 50 to 100, in the target magnetic tape group. The reserved physical storage spaces are used for copying. After repairing of the data block/parity block is completed, the corresponding p data blocks and q parity blocks that have undergone the repair processing are copied into the reserved physical storage spaces.

After the p data blocks and the q parity blocks that have undergone the repair processing are migrated to the respectively corresponding third physical storage spaces, index information corresponding to the p data blocks needs to be updated. The corresponding index information in an index system is modified to match the third physical storage spaces, and data blocks and metadata of the data blocks originally stored in the first physical storage spaces are deleted.

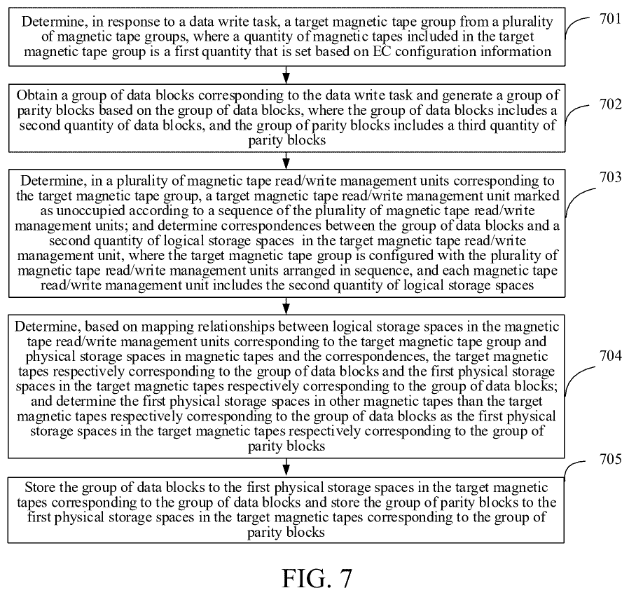

FIG. 7 is a flow chart of a data storage method according to an embodiment of the present disclosure. The method may be performed by the management server described above. As shown in FIG. 7, the method includes the following steps.
701: determine, in response to a data write task, a target magnetic tape group from a plurality of magnetic tape groups, where a quantity of magnetic tapes included in the target magnetic tape group is a first quantity that is set based on EC configuration information.
702: obtain a group of data blocks corresponding to the data write task and generate a group of parity blocks based on the group of data blocks, where the group of data blocks includes a second quantity of data blocks, and the group of parity blocks includes a third quantity of parity blocks.
703: determine, in a plurality of magnetic tape read/write management units corresponding to the target magnetic tape group, a target magnetic tape read/write management unit marked as unoccupied according to a sequence of the plurality of magnetic tape read/write management units; and determine correspondences between the group of data blocks and a second quantity of logical storage spaces in the target magnetic tape read/write management unit, where the target magnetic tape group is configured with the plurality of magnetic tape read/write management units arranged in sequence, and each magnetic tape read/write management unit includes the second quantity of logical storage spaces.
704: determine, based on mapping relationships between logical storage spaces in the magnetic tape read/write management units corresponding to the target magnetic tape group and physical storage spaces in magnetic tapes and the correspondences, the target magnetic tapes respectively corresponding to the group of data blocks and the first physical storage spaces in the target magnetic tapes respectively corresponding to the group of data blocks; and determine a first physical storage spaces in other magnetic tapes than the target magnetic tapes respectively corresponding to the group of data blocks as the first physical storage spaces in the target magnetic tapes respectively corresponding to the group of parity blocks.
705: store the group of data blocks to the first physical storage spaces in the target magnetic tapes corresponding to the group of data blocks and store the group of parity blocks to the first physical storage spaces in the target magnetic tapes corresponding to the group of parity blocks.

In this embodiment, a logical concept is introduced, that is, the magnetic tape read/write management unit, which may be used by the management server to indirectly manage physical storage spaces of magnetic tapes in a magnetic tape group. In other words, the management server does not need to directly manage the physical storage space of the magnetic tape. The management server only needs to maintain a plurality of corresponding magnetic tape read/write management units for each magnetic tape group, and presets a mapping relationship between each magnetic tape read/write management unit and a physical storage space of each magnetic tape in the magnetic tape group.

In addition, the magnetic tape read/write management unit is also visible to an application system triggering a data read/write task. In this way, it is convenient for the application system to read data. For example, the application system may learn which data is stored in which magnetic tape read/write management unit without a need of concerning about a physical storage space in which the data is stored.

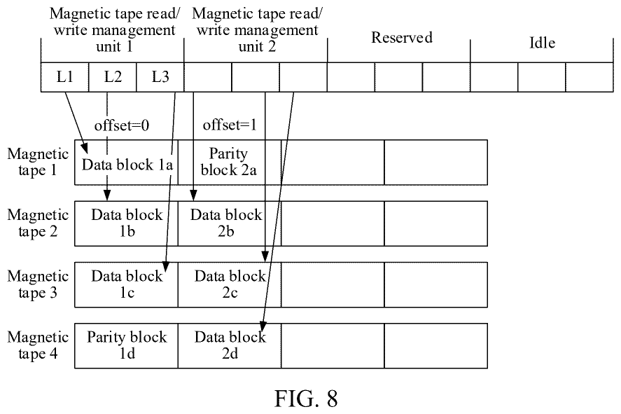

For ease of understanding the concept of the magnetic tape read/write management unit, an exemplary description is provided with reference to FIG. 8.

In FIG. 8, it is assumed that there is a case in which EC configuration is: 3+1, to be specific, there are three data blocks and one parity block, in other words, n=p+q=3+1, so that one magnetic tape group includes four magnetic tapes, that is, a magnetic tape 1 to a magnetic tape 4 shown in this figure. A plurality of magnetic tape read/write management units are set for matching the magnetic tape group. The plurality of magnetic tape read/write management units are sequenced, for example, the magnetic tape read/write management units are sequentially numbered as a magnetic tape read/write management unit 1, a magnetic tape read/write management unit 2, and so on shown in this figure. Some of the magnetic tape read/write management units are reserved, and some of the magnetic tape read/write management units may be currently in an unoccupied idle state.

Each magnetic tape read/write management unit includes p logical storage spaces, for example, the following three logical storage spaces in the magnetic tape read/write management unit 1 in FIG. 8: L1, L2, and L3. The p logical storage spaces actually correspond to the p data blocks, so that the application system can perceive a magnetic tape read/write management unit in which the p data blocks are stored, where the p data blocks are generated based on to-be-stored data.

For a plurality of magnetic tape read/write management units corresponding to one magnetic tape group, a mapping relationship between a logical storage space in a magnetic tape read/write management unit and a physical storage space in each magnetic tape in the group may be preset.

A mapping relationship between a number of a magnetic tape read/write management unit and an offset corresponding to a physical storage space may be first sequentially established. For example, the magnetic tape read/write management unit 1 shown in FIG. 8 corresponds to offset=0, and the magnetic tape read/write management unit 2 corresponds to offset=1, and so on.

Then, using the magnetic tape read/write management unit 1 as an example, mapping relationships between three logical storage spaces in the magnetic tape read/write management unit 1 and physical storage spaces with offsets being equal to 0 are established. As shown in FIG. 8, the three logical storage spaces in the magnetic tape read/write management unit 1 are sequentially mapped to the physical storage spaces with offsets being equal to 0 in the magnetic tape 1, the magnetic tape 2, and the magnetic tape 3, and a physical storage space with an offset being equal to 0 in the magnetic tape 4 is used for storing the parity block generated based on the three data blocks stored into the three logical storage spaces.

For example, after the data block 1a, the data block 1b, and the data block 1c shown in FIG. 8 and generated based on the to-be-stored data are received from the application system, it is determined, according to a sequence of the magnetic tape read/write management units, that the magnetic tape read/write management unit 1 is currently in an idle state. The three data blocks respectively correspond to the three logical storage spaces in the magnetic tape read/write management unit 1, and may be randomly allocated. Then, based on the mapping relationships between the three logical storage spaces in the magnetic tape read/write management unit 1 and the physical storage spaces in magnetic tapes in the magnetic tape group, three physical storage spaces with offsets being equal to 0 in the magnetic tapes 1 to 3 shown in FIG. 8 are determined, the three data blocks are correspondingly stored in the corresponding physical storage spaces, and the parity block 1d generated based on the three data blocks is stored into the physical storage space with an offset being equal to 0 in the remaining magnetic tape 4.

Similarly, based on mapping relationships, shown in FIG. 8, between three logical storage spaces in the magnetic tape read/write management unit 2 and physical storage spaces with offsets being equal to 1 in the magnetic tapes 2 to 4 in the magnetic tape group, when a next group of data blocks (a data block 2b, a data block 2c, and a data block 2d) are generated, it is determined that the magnetic tape read/write management unit 2 is unoccupied, the three data blocks corresponding to the three logical storage spaces are correspondingly stored in the physical storage spaces with offsets being equal to 1 in the magnetic tapes 2 to 4, and a generated parity block 2a is stored in a physical storage space with an offset being equal to 1 in the remaining magnetic tape 1, and so on.

It should be noted that although it is described above that a logical storage space corresponding to a data block in a magnetic tape read/write management unit needs to be determined, since the magnetic tape read/write management unit is only a logical concept rather than a storage medium, the data block is not stored in the logical storage space, and a correspondence between the data block and the logical storage space is established, to finally map the data block to the physical storage space for storage.

The magnetic tape read/write management unit is introduced as a read/write service externally provided by the magnetic tape group, so that magnetic tape read/write management is facilitated, which is more friendly for a user.

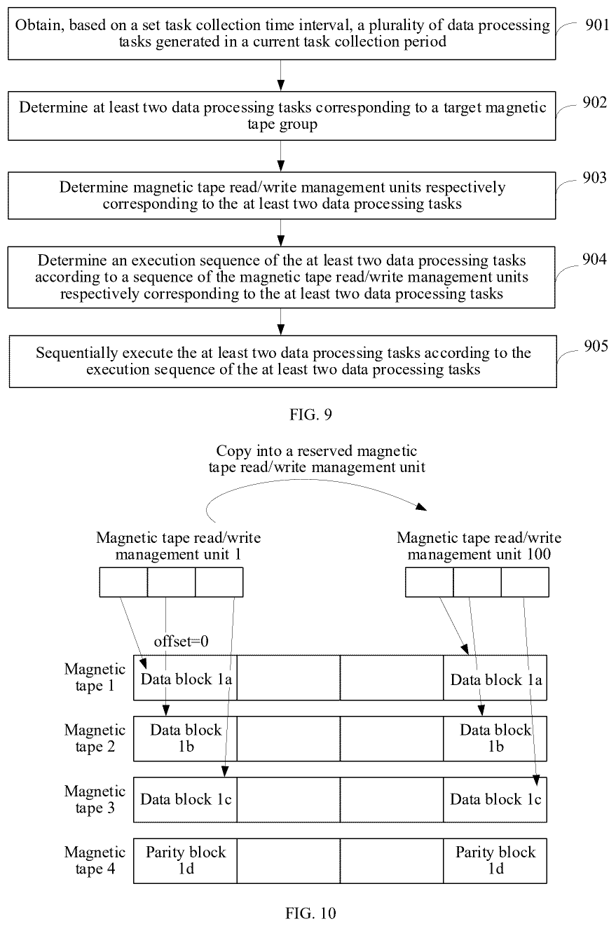

FIG. 9 is a flow chart of a data storage method according to an embodiment of the present disclosure. The method may be performed by the management server described above. As shown in FIG. 9, the method includes the following steps.
901: obtain, based on a set task collection time interval, a plurality of data processing tasks generated in a current task collection period.
902: determine at least two data processing tasks corresponding to a target magnetic tape group.
903: determine magnetic tape read/write management units respectively corresponding to the at least two data processing tasks.
904: determine an execution sequence of the at least two data processing tasks according to a sequence of the magnetic tape read/write management units respectively corresponding to the at least two data processing tasks.
905: sequentially execute the at least two data processing tasks according to the execution sequence of the at least two data processing tasks.

A data read/write task in a data archiving scenario may be usually categorized into the following four types of tasks: an archiving task (that is, a data write task), a read-back task (that is, a data reading task), a data verification task, and a data repair task. Where the archiving task, the data verification task, and the data repair task all belong to background tasks, and generally have delay requirements at a several-day level or even at a week level. A delay requirement of the read-back task is also at a tens of hours level. Therefore, these tasks are not sensitive to a delay. A sequence feature of the magnetic tape determines its poor capability in processing burst random IO (Input-Output). Based on this, in this embodiment of the present disclosure, a batch task processing solution is designed based on a feature of a task being not sensitive to a delay and the foregoing feature of a magnetic tape medium, to optimize a throughput capability of a magnetic tape.

The sequence feature of the magnetic tape is that the magnetic tape can only be rotated sequentially at a slow speed to arrive at a desired reading location. The random IO refers to the following. For example, many requests for reading data are sequentially received, and offsets corresponding to reading locations are random, for example, 100, 80, 90, 40, and 0. If the data is directly read according to this sequence, there are many invalid magnetic tape rotations, to be specific, the magnetic tape is frequently rotated back and forth in different directions. If the sequence is 0, 40, 80, 90, and 100, the problem is resolved.

In summary, a task processing method of a so called batch processing is: obtaining, based on a set task collection time interval (for example, several hours), a plurality of data processing tasks generated in a current task collection period; converting the plurality of data processing tasks into an operation on a magnetic tape read/write management unit; then determining an execution sequence of the data processing tasks according to a sequence of the magnetic tape read/write management units corresponding to the data processing tasks; and finally, based on a mapping relationship between a magnetic tape read/write management unit and a physical storage space in a magnetic tape, converting the data processing tasks into a parallel executed magnetic tape read/write operation.

The following briefly describes what needs to be completed for the foregoing four types of tasks.

For the archiving task, an idle magnetic tape read/write management unit is allocated, to determine, based on the allocated magnetic tape read/write management unit, a mapped physical storage space, so as to finally write a corresponding data block into the physical storage space in the magnetic tape.

For the read-back task, index information of to-be-read data is queried, to determine a magnetic tape read/write management unit corresponding to the to-be-read data and a location of the to-be-read data in the magnetic tape read/write management unit, so as to map the to-be-read data to a corresponding physical storage space, and read the data from the physical storage space. It may be understood that, after the logical concept of the magnetic tape read/write management unit is introduced, the index information includes an identifier of the magnetic tape read/write management unit corresponding to the data block and record information of the location of the data block in the magnetic tape read/write management unit.

For the data verification task, a group of magnetic tape read/write management units on which verification processing is not performed for a long time is allocated to wait for verification, where a verification process is to read a data block/parity block stored in a mapped physical storage space, calculate the CRC code, and compare the CRC code with a CRC code generated during writing. If the CRC code is inconsistent with the CRC code generated during writing, the data repair task is triggered.

For the data repair task, if a data block/parity block is damaged in a physical storage space to which a magnetic tape read/write management unit is mapped, repair processing of the damaged data needs to be performed based on related repairing data. For a repair processing process, refer to related descriptions in the foregoing other embodiments.

As described above, for the data repair task, after the faulty block is repaired, the p data blocks and the corresponding q parity blocks that have undergone the repairing are copied into another physical storage space. Descriptions are provided with reference to an example in FIG. 10.

In FIG. 10, it is assumed that an original data block 1a, a data block 1b, and a data block 1c are allocated to a magnetic tape read/write management unit 1, and are finally mapped to first physical storage spaces with offsets being equal to 0 in magnetic tapes 1 to 3. A parity block 1d generated based on the three data blocks is stored in a first physical storage space with an offset being equal to 0 in a magnetic tape 4. Assuming that a block in the four blocks is faulty, after repairing of the faulty block is completed based on the remaining three blocks, as shown in FIG. 10, a magnetic tape read/write management unit such as a magnetic tape read/write management unit 100 may be determined from reserved magnetic tape read/write management units, and further the foregoing four blocks are respectively copied, based on corresponding magnetic tapes, into physical storage spaces that are of the magnetic tapes and that correspond to the magnetic tape read/write management unit 100. Then, index information corresponding to the data blocks is updated.

It should be noted that when the original data block 1a, the data block 1b, the data block 1c, and the parity block 1d are written into the foregoing first physical storage spaces, if at least one of the blocks is not successfully written, a new magnetic tape read/write management unit such as a magnetic tape read/write management unit 2 needs to be replaced in this case, so that the four blocks are finally stored in physical storage spaces to which the magnetic tape read/write management unit 2 is mapped. Where the replaced magnetic tape read/write management unit is a non-reserved magnetic tape read/write management unit, to be specific, cannot be a reserved magnetic tape read/write management unit reserved for data repairing and used for copying.

An overall execution process of a batch task processing solution is described below.

First, based on a set task collection time interval, a plurality of data processing tasks generated in a current task collection period are obtained.

The current task collection period is a time period from an end time of a last collection task to a current time after the foregoing time interval. During this period, the plurality of different types of tasks may be sequentially received, and each type of task may be received more than once.

Except the archiving task, another types of tasks carry identification information such as a magnetic tape group identifier and a magnetic tape read/write management unit identifier when being triggered, so that a magnetic tape group corresponding to these data processing tasks can be directly determined. However, for the archiving task, as described above, a magnetic tape group corresponding to the archiving task may be allocated based on a remaining storage capacity of each magnetic tape group in an SD.

Therefore, a data processing task corresponding to each magnetic tape group can be determined. Data processing tasks corresponding to different magnetic tape groups may be executed in parallel, and different data processing tasks in a same magnetic tape group are executed in sequence.

For ease of description, since processing logic for each magnetic tape group is the same, any one of the magnetic tape groups is used as a target magnetic tape group for description.

In this embodiment, it is assumed that the target magnetic tape group corresponds to at least two data processing tasks. For the at least two data processing tasks, the data processing tasks are not executed according to a receiving time sequence of the data processing tasks, the reason is that the foregoing “random IO” may occur due to sequential execution.

For the at least two data processing tasks, first, magnetic tape read/write management units respectively corresponding to the at least two data processing tasks are determined. In other words, the at least two data processing tasks are converted into operations on the magnetic tape read/write management units.

For an archiving task included in the data processing tasks, an idle magnetic tape read/write management unit may be determined according to a sequence of the magnetic tape read/write management units, to process the archiving task. For a data repair task, a read-back task, or a data verification task, which will carry a magnetic tape group identifier and a magnetic tape read/write management unit identifier, so that a corresponding magnetic tape read/write management unit can be directly determined.

Then an execution sequence of the at least two data processing tasks is determined according to a sequence of the magnetic tape read/write management units respectively corresponding to the at least two data processing tasks. For example, sorting is performed in ascending order according to numbers of the corresponding magnetic tape read/write management units, to determine the execution sequence of the at least two data processing tasks.

Then the at least two data processing tasks are sequentially executed according to the execution sequence of the at least two data processing tasks. Specifically, the operation on the magnetic tape read/write management unit needs to be converted into an operation on a corresponding physical storage space in each magnetic tape in the target magnetic tape group, and then a corresponding read/write operation on the physical storage space in the magnetic tape is performed. Specifically, the management server may allocate an idle magnetic tape drive to each magnetic tape in the target magnetic tape group, to control the magnetic tape drive to rotate the magnetic tape to a required location to perform a corresponding data read/write operation.

Since the sequence of the magnetic tape read/write management units corresponding to the above at least two data processing tasks actually reflects a sequence of the physical storage spaces in the magnetic tapes corresponding to the data processing tasks, in other words, the sorted physical storage spaces corresponding to the data processing tasks may present an offset sequence in ascending order, in this case, the magnetic tape only needs to be rotated in one direction to a location corresponding to a physical storage space, to execute a corresponding data processing task.

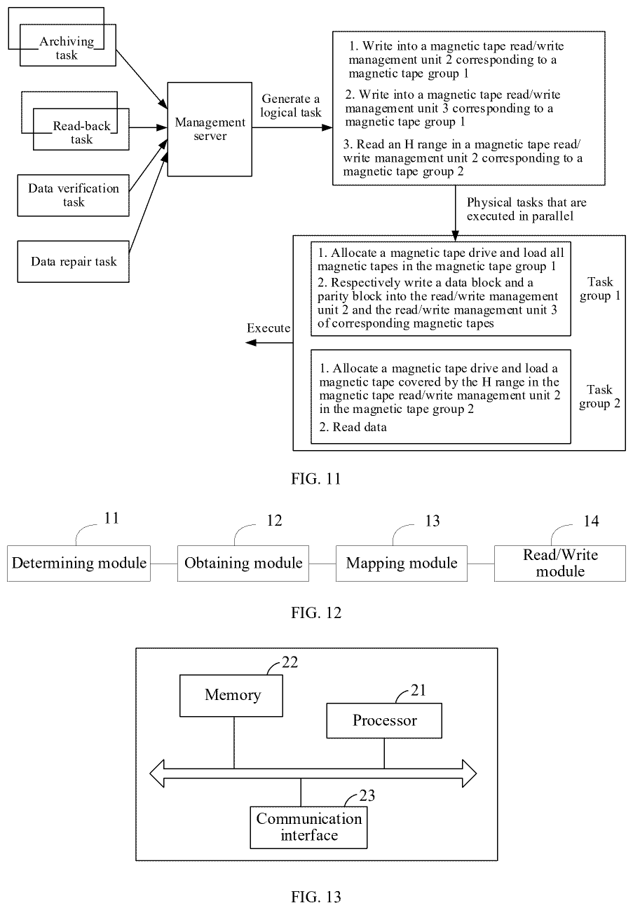

The following describes the foregoing batch task processing method by using an example with reference to FIG. 11.

In FIG. 11, it is assumed that in a current task collection period, the management server receives a plurality of types of tasks, and then generates three logical tasks shown in this figure. The logical task describes an operation on a magnetic tape read/write management unit corresponding to a magnetic tape group. Then, physical tasks that may be executed in parallel are generated based on magnetic tape groups corresponding to the logical tasks and a sequence of the magnetic tape read/write management units. The physical task describes a read/write operation on a magnetic tape. Where the parallel execution is for different magnetic tape groups, and the sequence of the magnetic tape read/write management units determines an execution sequence of the physical tasks. In FIG. 11, two task groups executed in parallel are respectively represented as a task group 1 and a task group 2, and respectively correspond to a magnetic tape group 1 and a magnetic tape group 2. Then, tasks included in each task group are executed in sequence. A magnetic tape drive is allocated based on task generated by using a plan, to load a corresponding magnetic tape, a corresponding data read/write operation on the magnetic tape is completed, and index information is updated after witting is successful.

In this embodiment, for a feature of a magnetic tape and a feature of various types of tasks being not sensitive to a delay, a task processing method of generating deterministic magnetic tape loading and a read/write task by using a batch plan is provided, to optimize a throughput capability of the magnetic tape.

The following describes a data storage apparatus according to one or more embodiments of the present disclosure in detail. A person skilled in the art may understand that these apparatuses may be constructed by using commercial hardware components and by using steps taught in this solution.

FIG. 12 is a schematic structural diagram of a data storage apparatus according to an embodiment of the present disclosure. The apparatus is used in a management server. As shown in FIG. 12, the apparatus includes: a determining module 11, an obtaining module 12, a mapping module 13, and a read/write module 14.

The determining module 11 is configured to determine, in response to a data write task, a target magnetic tape group from a plurality of magnetic tape groups, where a quantity of magnetic tapes included in the target magnetic tape group is a first quantity that is set based on erasure coding configuration information.

The obtaining module 12 is configured to obtain a group of data blocks corresponding to the data write task and generate a group of parity blocks based on the group of data blocks, where the group of data blocks includes a second quantity of data blocks, the group of parity blocks includes a third quantity of parity blocks, and the first quantity is a sum of the second quantity and the third quantity.

The mapping module 13 is configured to determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, where each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks.

The read/write module 14 is configured to store the group of data blocks to the first physical storage spaces in the target magnetic tapes corresponding to the group of data blocks and store the group of parity blocks to the first physical storage spaces in the target magnetic tapes corresponding to the group of parity blocks.

In an implementation, the apparatus further includes: an index module, configured to generate index information respectively corresponding to the group of data blocks; store the index information respectively corresponding to the group of data blocks in an index system, for use during data block query; and store the index information respectively corresponding to the group of data blocks in the first physical storage spaces respectively corresponding to the group of data blocks, correspondingly, to recover abnormal index information when the abnormal index information exists in the index system.

In an implementation, the obtaining module 12 is further configured to obtain a next group of data blocks corresponding to the data write task and generate a next group of parity blocks based on the next group of data blocks, where the next group of data blocks includes a second quantity of data blocks, and the next group of parity blocks includes a third quantity of parity blocks. The mapping module 13 is further configured to determine, from the target magnetic tape group, target magnetic tapes and second physical storage spaces in the target magnetic tapes corresponding to the next group of data blocks, and target magnetic tapes and second physical storage spaces in the target magnetic tapes corresponding to the next group of parity blocks, where the target magnetic tapes corresponding to the next group of parity blocks are different from the target magnetic tapes corresponding to the group of parity blocks. The read/write module 14 is further configured to store the next group of data blocks to the second physical storage spaces in the target magnetic tapes corresponding to the next group of data blocks and store the next group of parity blocks to the second physical storage spaces in the target magnetic tapes corresponding to the next group of parity blocks.

In an implementation, the apparatus further includes: a repair module, configured to: obtain, in response to a data repair task of any data block of the group of data blocks and/or a data repair task of any parity block of the group of parity blocks, a repair block from the first physical storage spaces of the magnetic tapes in the target magnetic tape group based on the first physical storage space corresponding to a faulty block, where the faulty block is any data block that needs to be repaired and/or any parity block that needs to be repaired, and the repair block is a data block other than the faulty block in the group of data blocks and is a parity block other than the faulty block in the group of parity blocks; perform repair processing on the faulty block based on the repair block; and migrate the group of data blocks and the group of parity blocks that have undergone the repair processing to third physical storage spaces having a same offset and reserved in the target magnetic tapes respectively corresponding to the group of data blocks and the group of parity blocks.

Based on this, the index module is further configured to update index information corresponding to the group of data blocks.

In an implementation, the mapping module 13 is specifically configured to: determine, in a plurality of magnetic tape read/write management units corresponding to the target magnetic tape group, a target magnetic tape read/write management unit marked as unoccupied according to a sequence of the plurality of magnetic tape read/write management units, where the target magnetic tape group is configured with the plurality of magnetic tape read/write management units arranged in sequence, and each magnetic tape read/write management unit includes a second quantity of logical storage spaces; determine correspondences between the group of data blocks and the second quantity of logical storage spaces in the target magnetic tape read/write management unit; determine, based on mapping relationships between logical storage spaces in the magnetic tape read/write management units corresponding to the target magnetic tape group and physical storage spaces in magnetic tapes and the correspondences, the target magnetic tapes respectively corresponding to the group of data blocks and the first physical storage spaces in the target magnetic tapes respectively corresponding to the group of data blocks; and determine a first physical storage spaces in other magnetic tapes than the target magnetic tapes respectively corresponding to the group of data blocks as the first physical storage spaces in the target magnetic tapes respectively corresponding to the group of parity blocks.

In an implementation, the apparatus further includes: a task scheduling module, configured to obtain, based on a set task collection time interval, a plurality of data processing tasks generated in a current task collection period; determine at least two data processing tasks corresponding to the target magnetic tape group, where the at least two data processing tasks include the data write task; determine magnetic tape read/write management units respectively corresponding to the at least two data processing tasks; determine an execution sequence of the at least two data processing tasks according to a sequence of the magnetic tape read/write management units respectively corresponding to the at least two data processing tasks; and sequentially execute the at least two data processing tasks according to the execution sequence of the at least two data processing tasks.

The apparatus shown in FIG. 12 may perform steps in the foregoing embodiments. For detailed execution processes and technical effects, refer to descriptions in the foregoing embodiments, and details are not described herein again.

In a possible design, the structure of the data storage apparatus shown in FIG. 12 may be implemented as an electronic device. As shown in FIG. 13, the electronic device may include: a processor 21, a memory 22, and a communication interface 23. The memory 22 stores an executable code. When the executable code is executed by the processor 21, the processor 21 may be enabled to implement at least the data storage method in the foregoing embodiments.

In addition, an embodiment of the present disclosure provides a non-transitory machine readable storage medium. The non-transitory machine readable storage medium stores an executable code, and when the executable code is executed by a processor of an electronic device, the processor is enabled to implement at least the data storage method according to the foregoing embodiments.

The foregoing described apparatus embodiments are merely examples. The units described as separate parts may or may not be physically separate. Some or all of the modules may be selected based on actual requirements to achieve the objectives of the solutions of this embodiment. A person of ordinary skill in the art may understand and implement the embodiments without creative efforts.

According to the descriptions in the foregoing implementations, a person skilled in the art may clearly learn that the implementations may be implemented by relying on software and a necessary general hardware platform, or may be implemented by combining the software and the hardware. Based on such an understanding, the foregoing technical solutions essentially, or the part thereof contributing to a conventional technology may be implemented in a form of a computer product. The present disclosure may use a form of a computer program product that is implemented on one or more computer-usable storage media (including but not limited to a magnetic disk memory, a compact disc read-only memory (CD-ROM), an optical memory, and the like) that include a computer-usable program code.

Finally, it should be noted that: the foregoing embodiments are merely used for describing the technical solutions of the present disclosure, rather than being intended to limit the present disclosure. Although the present disclosure is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements will not cause the essence of corresponding technical solutions to depart from the spirit and scope of the technical solutions in the embodiments of the present disclosure.

1. A data storage method, comprising:
determining, in response to a data write task, a target magnetic tape group from a plurality of magnetic tape groups, wherein a quantity of magnetic tapes comprised in the target magnetic tape group is a first quantity that is set based on erasure coding configuration information;
obtaining a group of data blocks corresponding to the data write task and generating a group of parity blocks based on the group of data blocks, wherein the group of data blocks comprises a second quantity of data blocks, the group of parity blocks comprises a third quantity of parity blocks, and the first quantity is a sum of the second quantity and the third quantity;
determining, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, wherein each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks;
storing the group of data blocks to the first physical storage spaces in the target magnetic tapes corresponding to the group of data blocks and storing the group of parity blocks to the first physical storage spaces in the target magnetic tapes corresponding to the group of parity blocks.

2. The method according to claim 1, wherein the method further comprises:
generating index information respectively corresponding to the group of data blocks;
storing the index information respectively corresponding to the group of data blocks in an index system, for use during data block query;
storing the index information respectively corresponding to the group of data blocks in the first physical storage spaces respectively corresponding to the group of data blocks, correspondingly, to recover abnormal index information when the abnormal index information exists in the index system.

3. The method according to claim 1, wherein the method further comprises:
obtaining a next group of data blocks corresponding to the data write task and generating a next group of parity blocks based on the next group of data blocks, wherein the next group of data blocks comprises a second quantity of data blocks, and the next group of parity blocks comprises a third quantity of parity blocks;
determining, from the target magnetic tape group, target magnetic tapes and second physical storage spaces in the target magnetic tapes corresponding to the next group of data blocks, and target magnetic tapes and second physical storage spaces in the target magnetic tapes corresponding to the next group of parity blocks, wherein the target magnetic tapes corresponding to the next group of parity blocks are different from the target magnetic tapes corresponding to the group of parity blocks;
storing the next group of data blocks to the second physical storage spaces in the target magnetic tapes corresponding to the next group of data blocks and storing the next group of parity blocks to the second physical storage spaces in the target magnetic tapes corresponding to the next group of parity blocks.

4. The method according to claim 1, wherein the method further comprises:
obtaining, in response to a data repair task of any data block of the group of data blocks and/or a data repair task of any parity block of the group of parity blocks, a repair block from the first physical storage spaces of the magnetic tapes in the target magnetic tape group based on the-a first physical storage space corresponding to a faulty block, wherein the faulty block is any data block that needs to be repaired and/or any parity block that needs to be repaired, and the repair block is a data block other than the faulty block in the group of data blocks and is a parity block other than the faulty block in the group of parity blocks;
performing repair processing on the faulty block based on the repair block;
migrating the group of data blocks and the group of parity blocks that have undergone the repair processing to third physical storage spaces having a same offset and reserved in the target magnetic tapes respectively corresponding to the group of data blocks and the group of parity blocks.

5. The method according to claim 4, wherein the method further comprises:
updating index information corresponding to the group of data blocks.

6. The method according to claim 1, wherein the determining, from the target magnetic tape group, the target magnetic tapes and the first physical storage spaces in the target magnetic tapes corresponding to the group of data blocks, and the target magnetic tapes and the first physical storage spaces in the target magnetic tapes corresponding to the group of parity blocks comprises:
determining, in a plurality of magnetic tape read/write management units corresponding to the target magnetic tape group, a target magnetic tape read/write management unit marked as unoccupied according to a sequence of the plurality of magnetic tape read/write management units, wherein the target magnetic tape group is configured with the plurality of magnetic tape read/write management units arranged in sequence, and each magnetic tape read/write management unit comprises a second quantity of logical storage spaces;
determining correspondences between the group of data blocks and the second quantity of logical storage spaces in the target magnetic tape read/write management unit;
determining, based on mapping relationships between logical storage spaces in the magnetic tape read/write management units corresponding to the target magnetic tape group and physical storage spaces in magnetic tapes and the correspondences, the target magnetic tapes respectively corresponding to the group of data blocks and the first physical storage spaces in the target magnetic tapes respectively corresponding to the group of data blocks;
determining first physical storage spaces in other magnetic tapes than the target magnetic tapes respectively corresponding to the group of data blocks as the first physical storage spaces in the target magnetic tapes respectively corresponding to the group of parity blocks.

7. The method according to claim 6, wherein the method further comprises:
obtaining, based on a set task collection time interval, a plurality of data processing tasks generated in a current task collection period;
determining at least two data processing tasks corresponding to the target magnetic tape group, wherein the at least two data processing tasks comprise the data write task;
determining magnetic tape read/write management units respectively corresponding to the at least two data processing tasks;
determining an execution sequence of the at least two data processing tasks according to a sequence of the magnetic tape read/write management units respectively corresponding to the at least two data processing tasks;
sequentially executing the at least two data processing tasks according to the execution sequence of the at least two data processing tasks.

8. An electronic device, comprising: a memory, a processor, and a communication interface, wherein the memory stores an executable code which, when executed by the processor, causes the processor to:
determine, in response to a data write task, a target magnetic tape group from a plurality of magnetic tape groups, wherein a quantity of magnetic tapes comprised in the target magnetic tape group is a first quantity that is set based on erasure coding configuration information;
obtain a group of data blocks corresponding to the data write task and generate a group of parity blocks based on the group of data blocks, wherein the group of data blocks comprises a second quantity of data blocks, the group of parity blocks comprises a third quantity of parity blocks, and the first quantity is a sum of the second quantity and the third quantity;
determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, wherein each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks;
store the group of data blocks to the first physical storage spaces in the target magnetic tapes corresponding to the group of data blocks and store the group of parity blocks to the first physical storage spaces in the target magnetic tapes corresponding to the group of parity blocks.

9. A non-transitory machine readable storage medium, wherein the non-transitory machine readable storage medium stores an executable code which, when executed by a processor of an electronic device, causes the processor to perform the data storage method according to claim 1.

10. A data storage system, comprising:
a management server, a plurality of magnetic tapes, and a plurality of magnetic tape drives;
wherein the management server is configured to:
determine, in response to a data write task, a target magnetic tape group from a plurality of magnetic tape groups, wherein a quantity of magnetic tapes comprised in the target magnetic tape group is a first quantity that is set based on erasure coding configuration information;
obtain a group of data blocks corresponding to the data write task and generate a group of parity blocks based on the group of data blocks, wherein the group of data blocks comprises a second quantity of data blocks, the group of parity blocks comprises a third quantity of parity blocks, and the first quantity is a sum of the second quantity and the third quantity;
determine, from the target magnetic tape group, target magnetic tapes and first physical storage spaces in the target magnetic tapes corresponding to the group of data blocks and target magnetic tapes and first physical storage spaces in the target magnetic tapes corresponding to the group of parity blocks, wherein each data block in the group of data blocks and each parity block in the group of parity blocks respectively correspond to different target magnetic tapes, and an offset of the first physical storage spaces corresponding to the group of data blocks is the same as an offset of the first physical storage spaces corresponding to the group of parity blocks;
store the group of data blocks to the first physical storage spaces in the target magnetic tapes corresponding to the group of data blocks and store the group of parity blocks to the first physical storage spaces in the target magnetic tapes corresponding to the group of parity blocks.

11. The electronic device according to claim 8, wherein the processor is further caused to:
generate index information respectively corresponding to the group of data blocks;
store the index information respectively corresponding to the group of data blocks in an index system, for use during data block query;
store the index information respectively corresponding to the group of data blocks in the first physical storage spaces respectively corresponding to the group of data blocks, correspondingly, to recover abnormal index information when the abnormal index information exists in the index system.

12. The electronic device according to claim 8, wherein the processor is further caused to:
obtain a next group of data blocks corresponding to the data write task and generate a next group of parity blocks based on the next group of data blocks, wherein the next group of data blocks comprises a second quantity of data blocks, and the next group of parity blocks comprises a third quantity of parity blocks;
determine, from the target magnetic tape group, target magnetic tapes and second physical storage spaces in the target magnetic tapes corresponding to the next group of data blocks, and target magnetic tapes and second physical storage spaces in the target magnetic tapes corresponding to the next group of parity blocks, wherein the target magnetic tapes corresponding to the next group of parity blocks are different from the target magnetic tapes corresponding to the group of parity blocks;
store the next group of data blocks to the second physical storage spaces in the target magnetic tapes corresponding to the next group of data blocks and store the next group of parity blocks to the second physical storage spaces in the target magnetic tapes corresponding to the next group of parity blocks.

13. The electronic device according to claim 8, wherein the processor is further caused to:
obtain, in response to a data repair task of any data block of the group of data blocks and/or a data repair task of any parity block of the group of parity blocks, a repair block from the first physical storage spaces of the magnetic tapes in the target magnetic tape group based on a first physical storage space corresponding to a faulty block, wherein the faulty block is any data block that needs to be repaired and/or any parity block that needs to be repaired, and the repair block is a data block other than the faulty block in the group of data blocks and is a parity block other than the faulty block in the group of parity blocks;
perform repair processing on the faulty block based on the repair block;
migrate the group of data blocks and the group of parity blocks that have undergone the repair processing to third physical storage spaces having a same offset and reserved in the target magnetic tapes respectively corresponding to the group of data blocks and the group of parity blocks.

14. The electronic device according to claim 13, wherein the processor is further caused to:
update index information corresponding to the group of data blocks.

15. The electronic device according to claim 8, wherein when determining, from the target magnetic tape group, the target magnetic tapes and the first physical storage spaces in the target magnetic tapes corresponding to the group of data blocks, and the target magnetic tapes and the first physical storage spaces in the target magnetic tapes corresponding to the group of parity blocks, the processor is specifically caused to:
determine, in a plurality of magnetic tape read/write management units corresponding to the target magnetic tape group, a target magnetic tape read/write management unit marked as unoccupied according to a sequence of the plurality of magnetic tape read/write management units, wherein the target magnetic tape group is configured with the plurality of magnetic tape read/write management units arranged in sequence, and each magnetic tape read/write management unit comprises a second quantity of logical storage spaces;
determine correspondences between the group of data blocks and the second quantity of logical storage spaces in the target magnetic tape read/write management unit;
determine, based on mapping relationships between logical storage spaces in the magnetic tape read/write management units corresponding to the target magnetic tape group and physical storage spaces in magnetic tapes and the correspondences, the target magnetic tapes respectively corresponding to the group of data blocks and the first physical storage spaces in the target magnetic tapes respectively corresponding to the group of data blocks;
determine a first physical storage spaces in other magnetic tapes than the target magnetic tapes respectively corresponding to the group of data blocks as the first physical storage spaces in the target magnetic tapes respectively corresponding to the group of parity blocks.

16. The electronic device according to claim 15, wherein the processor is further caused to:
obtain, based on a set task collection time interval, a plurality of data processing tasks generated in a current task collection period;
determine at least two data processing tasks corresponding to the target magnetic tape group, wherein the at least two data processing tasks comprise the data write task;
determine magnetic tape read/write management units respectively corresponding to the at least two data processing tasks;
determine an execution sequence of the at least two data processing tasks according to a sequence of the magnetic tape read/write management units respectively corresponding to the at least two data processing tasks;
sequentially execute the at least two data processing tasks according to the execution sequence of the at least two data processing tasks.

17. The system according to claim 10, wherein the management server is further configured to:
generate index information respectively corresponding to the group of data blocks;
store the index information respectively corresponding to the group of data blocks in an index system, for use during data block query;
store the index information respectively corresponding to the group of data blocks in the first physical storage spaces respectively corresponding to the group of data blocks, correspondingly, to recover abnormal index information when the abnormal index information exists in the index system.

18. The system according to claim 10, wherein the management server is further configured to:
obtain a next group of data blocks corresponding to the data write task and generate a next group of parity blocks based on the next group of data blocks, wherein the next group of data blocks comprises a second quantity of data blocks, and the next group of parity blocks comprises a third quantity of parity blocks;
determine, from the target magnetic tape group, target magnetic tapes and second physical storage spaces in the target magnetic tapes corresponding to the next group of data blocks, and target magnetic tapes and second physical storage spaces in the target magnetic tapes corresponding to the next group of parity blocks, wherein the target magnetic tapes corresponding to the next group of parity blocks are different from the target magnetic tapes corresponding to the group of parity blocks;
store the next group of data blocks to the second physical storage spaces in the target magnetic tapes corresponding to the next group of data blocks and store the next group of parity blocks to the second physical storage spaces in the target magnetic tapes corresponding to the next group of parity blocks.

19. The system according to claim 10, wherein the management server is further configured to:
obtain, in response to a data repair task of any data block of the group of data blocks and/or a data repair task of any parity block of the group of parity blocks, a repair block from the first physical storage spaces of the magnetic tapes in the target magnetic tape group based on a first physical storage space corresponding to a faulty block, wherein the faulty block is any data block that needs to be repaired and/or any parity block that needs to be repaired, and the repair block is a data block other than the faulty block in the group of data blocks and is a parity block other than the faulty block in the group of parity blocks;
perform repair processing on the faulty block based on the repair block;
migrate the group of data blocks and the group of parity blocks that have undergone the repair processing to third physical storage spaces having a same offset and reserved in the target magnetic tapes respectively corresponding to the group of data blocks and the group of parity blocks.

20. The system according to claim 19, wherein the management server is further configured to:
update index information corresponding to the group of data blocks.
